(19) United States
(12) Patent Application Publication
(10) Pub. No.: US 2007/0300216 A1
(43) Pub. Date: Dec. 27, 2007

(54) Information processing apparatus and recording medium containing program

(76) Inventor: Makoto Miyagi, Tokyo (JP)

Correspondence Address: DICKSTEIN SHAPIRO LLP, 1825 EYE STREET NW, Washington, DC, 20006-5403, US

(21) Appl. No.: 11/802,199

(22) Filed: May 21, 2007

(30) Foreign Application Priority Data
Jun. 21, 2006 (JP) 2006-171606

(51) Int. Cl. G06F 9/44

(52) U.S. Cl. 717/168

(57) ABSTRACT

An information processing apparatus for generating data that a device connected to the information processing apparatus can process is disclosed. The disclosed information processing apparatus includes a function information storage unit configured to store function information regarding functions provided by the device; a configuration information obtaining unit configured to obtain configuration information from the device which configuration information is the latest information on the functions provided by the device; an information comparing unit configured to compare the function information and the configuration information and to update the function information based on the results of the comparison; and a setting screen generating unit configured to generate a setting screen based on the updated function information.

### BACKGROUND OF THE INVENTION

1. Field of the Invention

The present invention generally relates to an information processing apparatus to be connected to peripheral devices and a recording medium containing program code for causing a computer to function as the information processing apparatus.

2. Description of the Related Art

An information processing apparatus such as a personal computer (PC) connected via a network to peripheral devices such as a printer, a scanner, and a facsimile normally includes device drivers (for example, a printer driver for a printer) for converting data created by application programs in the information processing apparatus into data (for example, data written in page description language (PDL) for a printer) that the peripheral devices can process.

For example, an information processing apparatus may contain multiple printer drivers for various types of printers connected to the information processing apparatus. The number of printer drivers normally corresponds to the number of printers used with the information processing apparatus. To simplify the management of device drivers, common device drivers called universal drivers that can be used without regard to the types of devices have been developed.

For example, Japanese Patent Application Publication No. 2002-91732 (patent document 1) discloses a universal printer driver and a method of obtaining and displaying a list of printers supporting the universal printer driver in a network system including printers supporting only proprietary printer drivers and printers supporting the universal printer driver. The technology disclosed in patent document 1 thus facilitates using multiple printers in a network with a universal printer driver.

Also, Japanese Patent Application Publication No. 2002-175258 (patent document 2) discloses a printer system with improved usability that eliminates the need to install a printer driver from scratch when adding a printer entry in a host computer. In the disclosed printer system, when the user first installs a printer driver, a core module is installed. The installed core module runs automatically and obtains device information from a printer assigned to an output port. The core module then loads device-dependent modules used as components of the printer driver based on the obtained device information.

Further, Japanese Patent Application Publication No. 11-203088 (patent document 3) discloses a printer driver program that installs a printer driver together with device-dependent information for multiple printers which device-dependent information is stored in a recording medium. When a target printer is selected by the user or determined by two-way communications to print data, the printer driver is configured to suit the target printer. Thus, the printer driver program disclosed in patent document 3 makes it possible to install in one operation a printer driver that supports multiple types of printers.

[Patent document 1] Japanese Patent Application Publication No. 2002-91732

[Patent document 2] Japanese Patent Application Publication No. 2002-175258

[Patent document 3] Japanese Patent Application Publication No. 11-203088

One disadvantage of the universal printer driver disclosed in patent document 1 is that it enables the user to make only basic settings such as paper sizes or print directions that are common to printers. Therefore, the user can use only part of functions provided by a printer.

Meanwhile, in the printer system disclosed in patent document 2, the number of device-dependent modules installed in a host computer increases as the number or types of printers increases. Accordingly, the increased number of device-dependent modules may use up the storage space of the host computer. Also, in the printer system, the layout of a printer driver user interface changes depending on the device-dependent modules used and this results in reduced operability.

Further, according to the technology disclosed in patent document 3, since the device-dependent information for printers is stored in a recording medium, device-dependent functions of a new printer are not usable unless the information for the new printer is stored in the recording medium.

### SUMMARY OF THE INVENTION

The present invention provides an information processing apparatus and a recording medium that substantially obviate one or more problems caused by the limitations and disadvantages of the related art.

Embodiments of the present invention provide an information processing apparatus configured to generate data suitable for each of multiple devices and to display a setting screen having a layout common to the multiple devices, and a recording medium containing program code for causing a computer to function as the information processing apparatus.

An embodiment of the present invention provides an information processing apparatus for generating data that a device connected to the information processing apparatus can process. The information processing apparatus according to an embodiment of the present invention includes a function information storage unit configured to store function information regarding functions provided by the device; a configuration information obtaining unit configured to obtain configuration information from the device which configuration information is the latest information on the functions provided by the device; an information comparing unit configured to compare the function information and the configuration information and to update the function information based on the results of the comparison; and a setting screen generating unit configured to generate a setting screen based on the updated function information.

### BRIEF DESCRIPTION OF THE DRAWINGS

FIG. 1 is a drawing illustrating a network configuration of an exemplary information processing system according to an embodiment of the present invention;

FIG. 2 is a block diagram illustrating a hardware configuration of an exemplary information processing apparatus according to an embodiment of the present invention;

FIG. 3 is a block diagram illustrating a functional configuration of the exemplary information processing apparatus;

FIG. 4 is a block diagram illustrating an exemplary detailed configuration of a printer driver shown in FIG. 3;

FIG. 5 is a drawing illustrating an exemplary basic setting screen displayed by the exemplary information processing apparatus;

FIG. 6 is a table showing basic function information used to display the exemplary basic setting screen of FIG. 5;

FIG. 7 is a drawing illustrating another exemplary basic setting screen displayed by the exemplary information processing apparatus incorporating an exclusion condition;

FIG. 8 is a flowchart showing an exemplary process of updating function information by the exemplary information processing apparatus;

FIG. 9 is a flowchart showing an exemplary process of updating a setting screen by the exemplary information processing apparatus;

FIG. 10 is a table showing updated function information of Example 1;

FIG. 11 is a drawing illustrating a setting screen displayed based on the updated function information shown in FIG. 10;

FIG. 12 is a table showing updated function information of Example 2; and

FIG. 13 is a drawing illustrating a setting screen displayed based on the updated function information shown in FIG. 12.

### DESCRIPTION OF THE PREFERRED EMBODIMENTS

Preferred embodiments of the present invention are described below with reference to the accompanying drawings.

[Configuration]

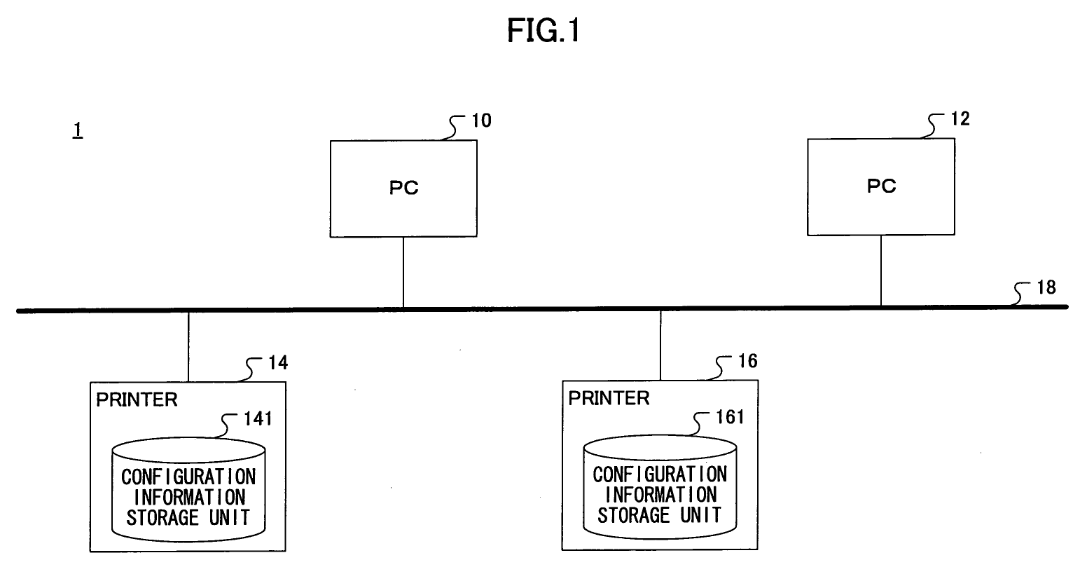

FIG. 1 is a drawing illustrating an exemplary network configuration of an information processing system according to an embodiment of the present invention.

An information processing system 1 shown in FIG. 1 includes information processing apparatuses 10 and 12 implemented by, for example, personal computers (PCs) and printers 14 and 16. The components of the information processing system 1 are connected via a network 18 such as a local area network (LAN).

The information processing apparatuses 10 and 12 have application programs installed therein. The application programs run on an operating system such as Microsoft Windows® and are used to generate data.

The printers 14 and 16 are used to print data generated by the application programs installed in the information processing apparatuses 10 and 12. The printers 14 and 16, respectively, include configuration information storage units 141 and 161 for storing configuration information regarding functions of the printers 14 and 16. The configuration information stored in the configuration information storage units 141 and 161 is sent via the network 18 to the information processing apparatuses 10 and 12 in response to requests from the information processing apparatuses 10 and 12.

The information processing system 1 shown in FIG. 1 may include more than two PCs (information processing apparatuses) and printers and may also include devices other than PCs and printers. Although the information processing apparatus 10 is taken as an example in descriptions below, the same descriptions may apply to the information processing apparatus 12.

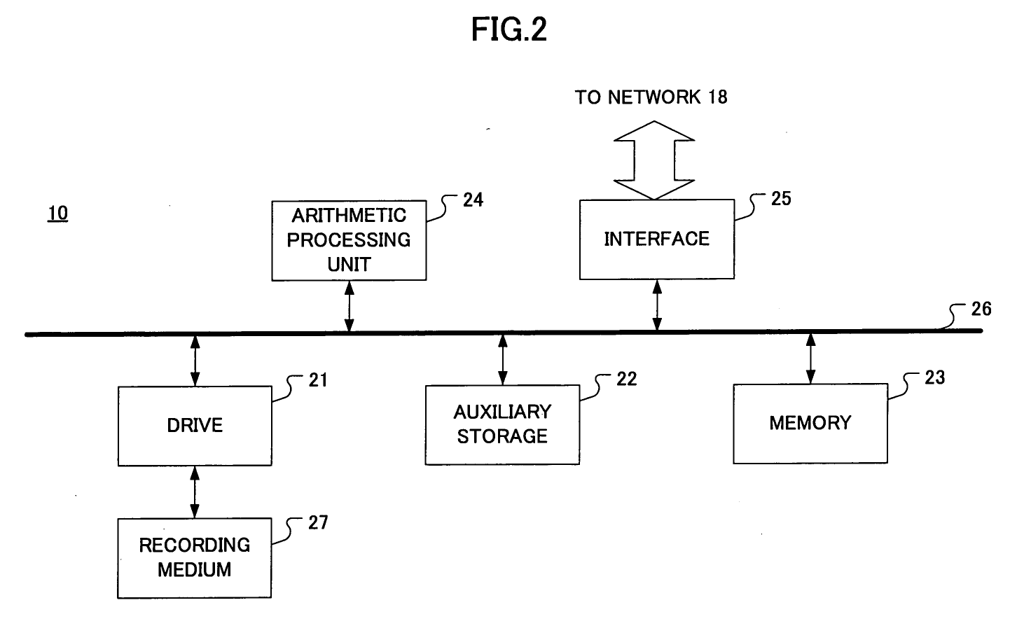

FIG. 2 is a block diagram illustrating an exemplary hardware configuration of the information processing apparatus 10.

As shown in FIG. 2, the information processing apparatus 10 includes a drive 21, an auxiliary storage 22, a memory 23, an arithmetic processing unit 24, and an interface 25 that are connected via a bus 26. Programs for performing various processes in the information processing apparatus 10 may be provided by a recording medium 27 such as a CD-ROM.

The drive 21 reads data from the recording medium 27. When the recording medium 27 containing programs is mounted on the drive 21, the programs are installed from the recording medium 27 via the drive 21 onto the auxiliary storage 22. In this embodiment, it is assumed that a device driver, for example, a printer driver described later is stored in the recording medium 27.

The auxiliary storage 22 stores installed programs and other files and data. The memory 23 temporarily stores a program retrieved from the auxiliary storage 22 when the program is executed. The arithmetic processing unit 24 performs a function of the information processing apparatus 10 according to the program temporarily stored in the memory 23. The interface 25 is used to connect the information processing apparatus 10 to a local area network or a public telecommunication network (for example, to the network 18 shown in FIG. 1).

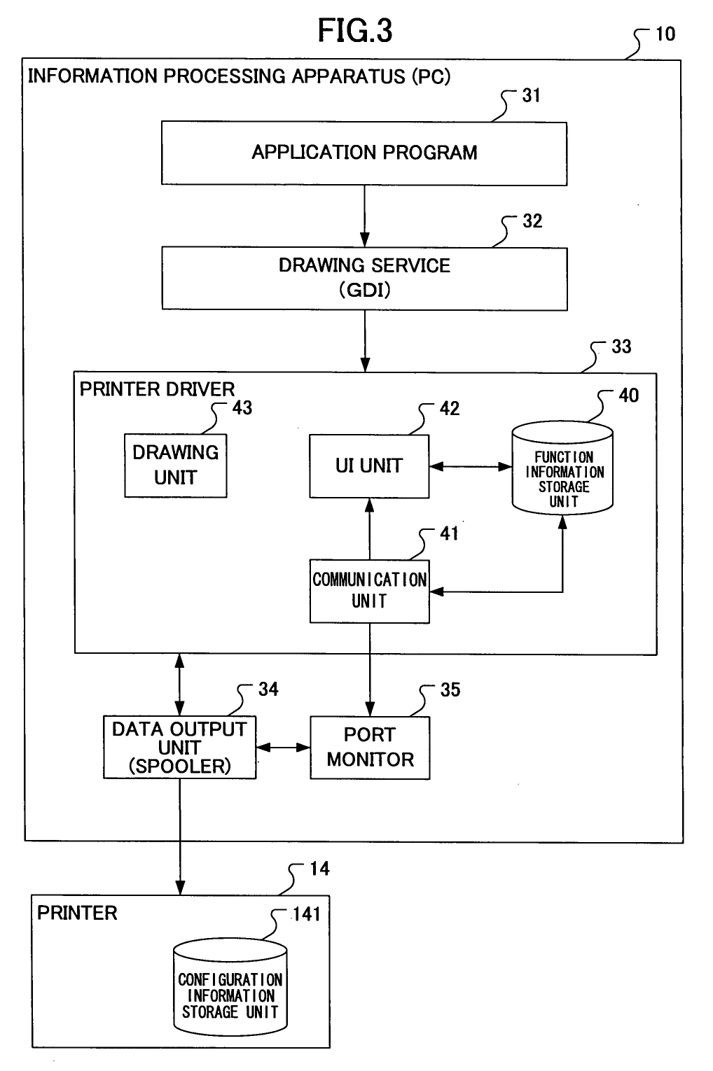

FIG. 3 is a block diagram illustrating an exemplary functional configuration of the information processing apparatus 10.

As shown in FIG. 3, the information processing apparatus 10 includes, as functional units, an application program 31, a drawing service 32, a printer driver 33 that is an example of a device driver, a data output unit 34, and a port monitor 35, and is connected via the network 18 to the printer 14. Although the printer 14 is used as an example in descriptions below, the same descriptions may apply to the printer 16.

The application program 31 runs on an operating system such as Microsoft Windows®. Examples of the application program 31 include a word processor and a spreadsheet.

The drawing service 32 is a drawing engine running on an operating system and is normally included in a graphics device interface (GDI) together with a program module interfacing the application program 31 and the drawing service 32.

The printer driver 33 includes a function information storage unit 40, a communication unit 41, a user interface (UI) unit 42, and a drawing unit 43. The printer driver 33 functions as a data conversion unit that converts internal instructions of an OS into page description language (PDL) data, which can be processed by a printer, based on function information regarding functions provided by the printer.

The function information storage unit 40 stores function information regarding functions provided by a printer connected to the information processing apparatus 10.

The communication unit 41 obtains configuration information stored, for example, in the configuration information storage unit 141 of the printer 14 and updates the function information stored in the function information storage unit 40 based on the obtained configuration information.

The UI unit 42 displays a setting screen for setting the functions of, for example, the printer 14 based on function information stored in the function information storage unit 40.

The drawing unit 43 converts data sent from the application 31 via the drawing service 32 into data that can be processed, for example, by the printer 14 based on settings specified on the setting screen displayed by the UI unit 42.

Normally, the drawing service 32 and the printer driver 33 are interfaced by a device driver interface (DDI).

The data output unit 34 is a spooler that spools PDL data generated by the printer driver 33. Normally, the output speed of a printer is much slower than the processing speed of a computer or an application program. Using a spooler makes it possible to release a computer or an application program from a task of sending data faster than when data are sent directly to a printer. This is especially beneficial when the data size is large. The spooler 34 sends the spooled PDL data from an output port via the network 18 to the printer 14.

The port monitor 35 monitors the output port sending the PDL data from the data output unit 34 to, for example, the printer 14.

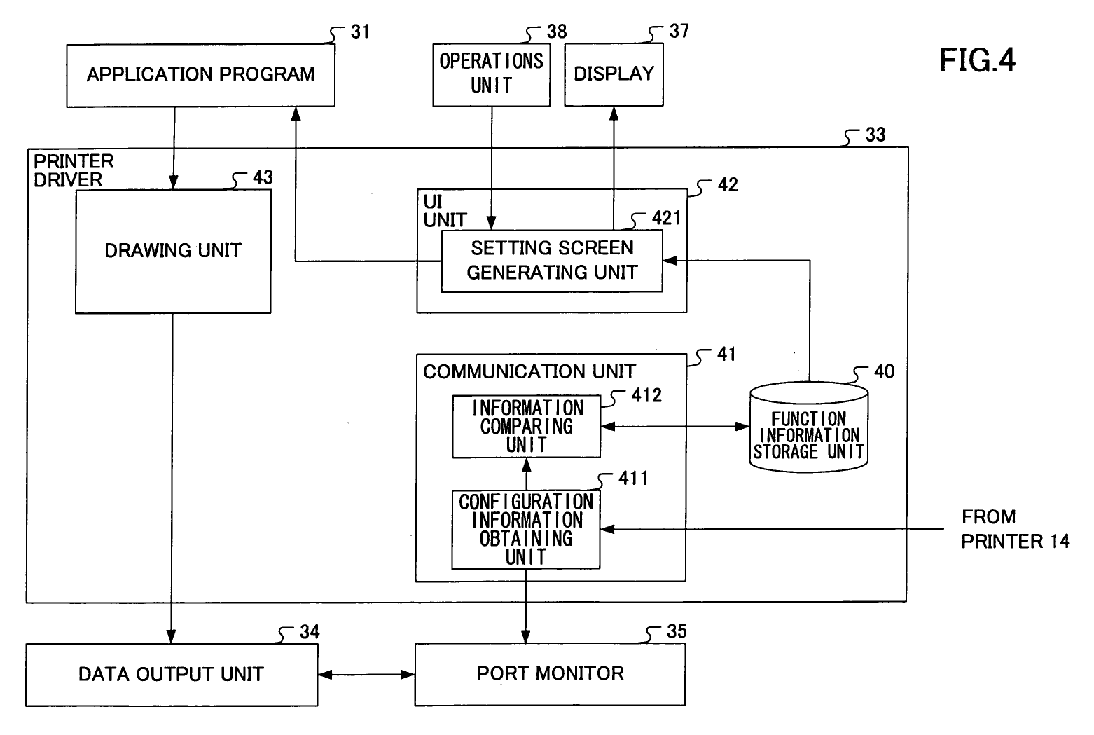

FIG. 4 is a block diagram illustrating an exemplary detailed configuration of the printer driver 33 shown in FIG. 3.

The printer driver 33, as described above, includes the function information storage unit 40, the communication unit 41, the user interface (UI) unit 42, and the drawing unit 43.

The communication unit 41 includes a configuration information obtaining unit 411 for obtaining configuration information regarding functions of a printer connected via a network; and an information comparing unit 412 for comparing the configuration information obtained by the configuration information obtaining unit 411 and the function information stored in the function information storage unit 40 and for updating the function information based on the result of comparison.

The UI unit 42 includes a setting screen generating unit 421 that displays, for example, on a display 37 a setting screen for setting the functions of the printer 14 based on function information stored in the function information storage unit 40. The setting screen generating unit 421 also receives setting values input on the setting screen by the user using an operations unit 38 such as a keyboard or a mouse.

The setting screen generating unit 421 sends the received setting values to the application program 31. When the user enters a print request, the application program 31 sends the setting values to the drawing unit 43 of the printer driver 33. Based on the setting values and commands contained in the function information stored in the function information storage unit 40, the drawing unit 43 converts data sent from the application program 31 via the drawing service 32 into data that can be processed by the printer 14. The drawing unit 43 sends the converted data to the data output unit 34.

Meanwhile, the communication unit 41 is connected to the port monitor 35. When a new target printer and the corresponding output port are selected, the communication unit 41 automatically obtains configuration information of the new target printer via the port monitor 35.

[Setting Screen]

When the printer driver 33 is installed in the information processing apparatus 10 for the first time, basic function information is stored in the function information storage unit 40. The basic function information is used to display a basic setting screen for setting basic functions provided by a universal driver that can be used without regard to the types of printers.

The basic function information stored in the function information storage unit 40 includes one or more of the following information items: a model name, a tab name, a function identifier, a function name, an element type, options, a default value, an exclusion condition, and a display option.

The model name indicates a printer name. The tab name indicates a name of a sub-screen or a tab in a setting screen. The function identifier indicates a function corresponding to a command in a printer language that information processing apparatuses and printers can understand. The function name indicates a name assigned to a function for display on a setting screen. The element type indicates a type of a setting element, such as a text box, a button, or a list box, displayed on a setting screen and used to make settings for a function. The options indicate a list of values provided in a setting element such as a list box that allows the user to select a value from the list. The default value indicates an initial value of each setting element. The exclusion condition defines the relationship between functions. More specifically, the exclusion condition limits options or functions that can be specified or used together with a certain option or function. Options or functions (setting elements) that are excluded by the exclusion condition are not displayed on the setting screen. For example, an exclusion condition may define that if “300 dpi” is selected from the “Resolution” options, only “monochrome” is selectable from the “Color/Monochrome” options. In this case, the other option “color” in the “Color/Monochrome” setting element is hidden. The display option indicates whether a setting element is displayed (On) or hidden (Off) on a setting screen.

The information items other than the model name in the basic function information are provided function by function and are collectively called a function entry. In other words, function information for each function (i.e., function entry) includes one or more of the tab name, the function identifier, the function name, the element type, the options, the default value, the exclusion condition, and the display option.

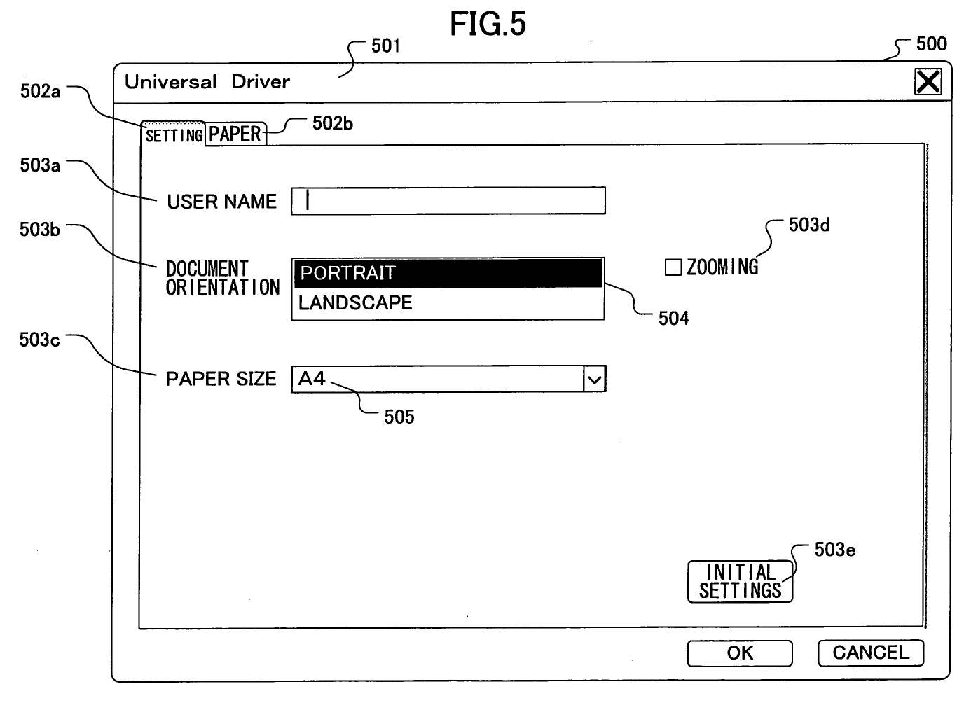

The setting screen generating unit 421 generates the basic setting screen, which is common to multiple printers, based on the basic function information. FIG. 5 is a drawing illustrating a basic setting screen 500 displayed by the information processing apparatus 10.

A model name 501 “Universal Driver” is shown on the title bar of the basic setting screen 500 in FIG. 5. The basic setting screen 500 includes two sub-screens (tabs) with a tab name 502a “Setting” and a tab name 502b “Paper”. The “Setting” sub-screen includes setting elements with function names 503a “User name”, 503b “Document orientation”, 503c “Paper size”, 503d “Zooming”, and 503e “Initial settings”.

The “User name” setting element is implemented as a text box, the “Document orientation” setting element as a list box (504), the “Paper size” setting element as a drop-down list box, and the “Initial settings” setting element as a button. The list box 504 of the “Document orientation” setting element includes “portrait” and “landscape” as options, and “portrait” is selected by default. In the “Paper size” setting element, a default value 505 “A4” is selected.

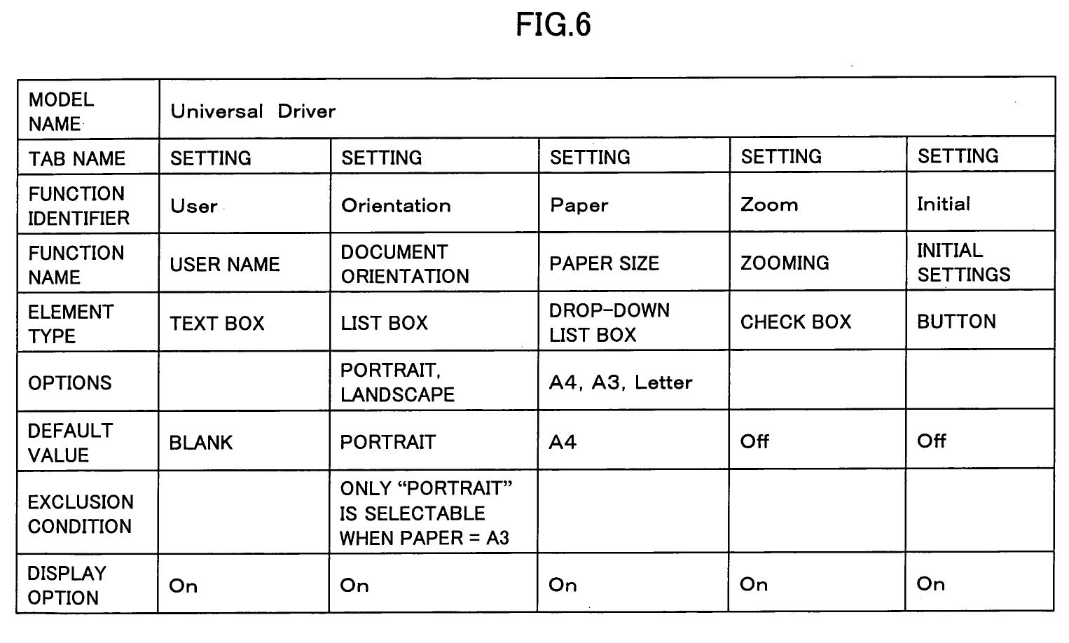

FIG. 6 is a table showing basic function information used to display the basic setting screen 500 of FIG. 5. The first row of the table contains the model name “Universal Driver”. The second and subsequent rows contain, for each function (or function entry), the tab name, the function identifier, the function name, the element type, the options, the default value, the exclusion condition, and the display option.

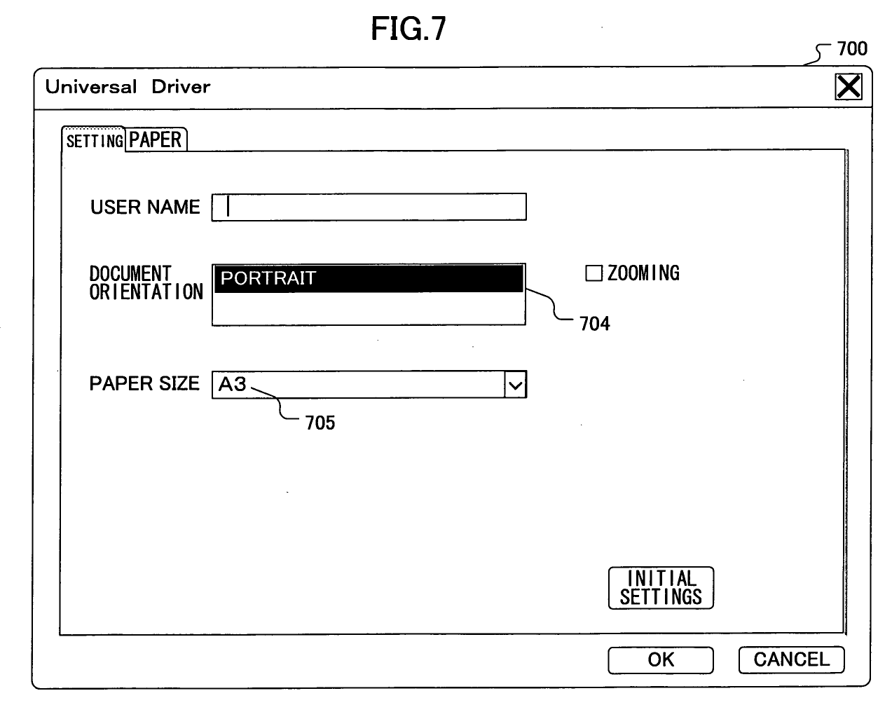

In FIG. 5, the exclusion condition for the “Document orientation” function defines that when “A3” is selected from the “Paper size” options, only “portrait” is selectable from the Document orientation” options. FIG. 7 is a drawing illustrating a basic setting screen 700 displayed by the information processing apparatus 10 incorporating the above exclusion condition.

The basic setting screen 700 has substantially the same layout as that of the basic setting screen 500 shown in FIG. 5. One difference is that when an option 705 “A3” is selected from the “Paper size” options, only the option “portrait” is displayed in a list box 704 of the “Document orientation” setting element as defined by the exclusion condition for the “Document orientation” function. As an alternative, the option “landscape” may appear dimmed in the list box 704 so that the user cannot select it.

[Operations]

Exemplary processes of updating function information stored in the function information storage unit 40 based on configuration information obtained from a device and of changing the layout of a setting screen according to the updated function information are described below with reference to FIGS. 4, 8, and 9.

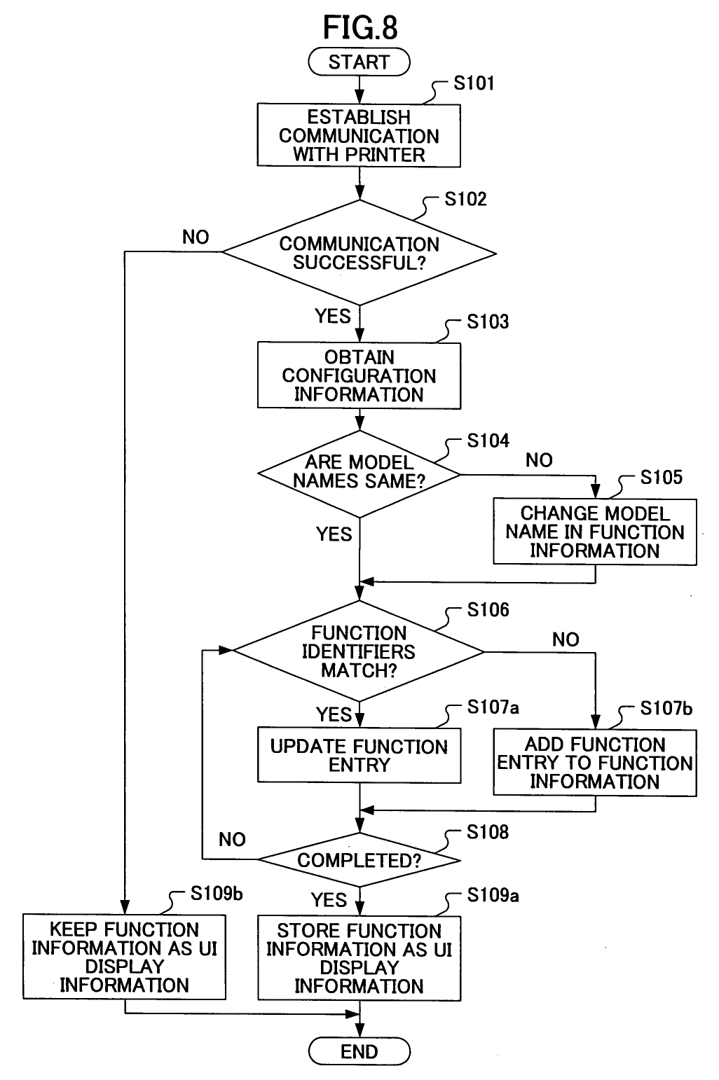

FIG. 8 is a flowchart showing an exemplary process of updating function information by the information processing apparatus 10.

In the exemplary process shown in FIG. 8, it is assumed that function information is already stored in the function information storage unit 40.

In step S101, the communication unit 41 tries to establish communication with the printer 14. If communication with the printer is established successfully in step S102, the configuration information obtaining unit 411 of the communication unit 41, in step S103, obtains configuration information stored in the configuration information storage unit 141 of the printer 14 and the information comparing unit 412 compares the obtained configuration information with the function information stored in the function information storage unit 40.

In step S104, the information comparing unit 412 compares a model name (in this example, a printer name) contained in the obtained configuration information of the printer 14 and a model name contained in the function information. If the model names are different, the information comparing unit 412 replaces the model name in the function information with the model name in the configuration information in step S105.

In step S106, the information comparing unit 412 compares a function identifier contained in the configuration information with the function identifiers contained in the function information. If the function identifier in the configuration information matches a function identifier in the function information, the information comparing unit 412, in step S107a, replaces the information items (like those shown in FIG. 6) other than the tab name of a function entry contained in the function information and having the matching function identifier with the corresponding information items in the configuration information. If the function identifier in the configuration information does not match any of the function identifiers in the function information, the information comparing unit 412, in step S107b, adds the function identifier and the corresponding information items contained in the configuration information to the function information. Meanwhile, if a function identifier in the function information does not match any of the function identifiers in the configuration information, the information comparing unit 412 changes the function entry corresponding to the function identifier (for example, sets the display option to “Off”) so that the user cannot make settings for the corresponding function. Steps S106 and S107a or S107b are repeated until the information comparing unit 412 determines, in step S108, that comparison of all function identifiers in the configuration information is completed.

Then, in step S109a, the function information storage unit 40 stores the function information updated through the above steps as UI display information used by the UI unit 42 to display a setting screen.

Meanwhile, if the communication unit 41 fails to establish communication with the printer 14 in step S102, the function information storage unit 40, in step S109b, keeps the initially-stored function information as the UI display information.

The UI display information stored in the function information storage unit 40 is not updated until another printer, for example, the printer 16 is selected on the information processing apparatus 10.

Thus, an information processing apparatus of this embodiment is configured to obtain configuration information regarding functions of a device on demand and to update function information based on the obtained configuration information. This configuration makes it possible to use different types of devices, which are connected to an information processing apparatus, with one device driver. Also, an information processing apparatus of this embodiment may be configured to add new function entries to function information when new functions are added to a device. This configuration eliminates the need to reinstall a device driver even when a device is upgraded and thereby makes it possible to easily adapt to an upgrade of a device.

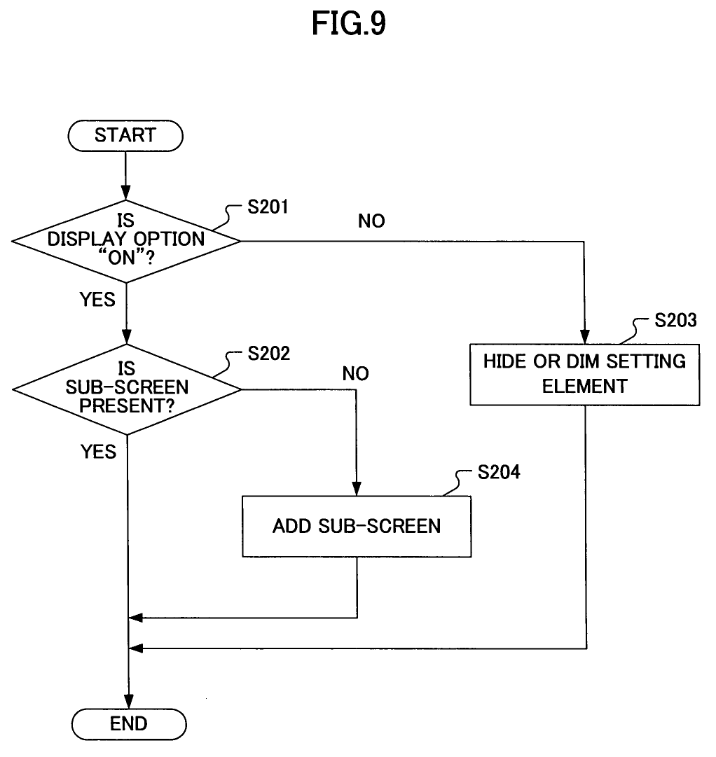

FIG. 9 is a flowchart showing an exemplary process of updating a setting screen by the information processing apparatus 10.

After the UI display information is stored in the function information storage unit 40 as described above with reference to FIG. 8, the setting screen generating unit 421 of the UI unit 42, in step S201, determines whether the display option of each of the function entries in the UI display information is “On” or “Off”. The display options of function entries corresponding to functions not available in a current device are set to “Off” so that the user cannot make settings for those unavailable functions.

If the display option of a function entry is “Off”, the setting screen generating unit 421, in step S203, hides or dims the setting element representing the function entry so that the user cannot make settings for the corresponding function.

If the display option of a function entry is “On”, the setting screen generating unit 421, in step S202, refers to the UI display information for the tab name of the function entry and determines whether a sub-screen having the tab name is present in the setting screen. If no sub-screen having the tab name is present in the setting screen, the setting screen generating unit 421, in step S204, adds a sub-screen having the tab name to the setting screen. Meanwhile, if a tab name of a sub-screen already in the setting screen is not contained in the UI display information, the setting screen generating unit 421 hides or dims the tab name or the sub-screen including the tab name on the setting screen so that the user cannot use the sub-screen.

Thus, an information processing apparatus of this embodiment is configured to update only a portion of a setting screen to adapt it to a current device. This configuration eliminates the need to change the layout of a setting screen for each device and provides improved operability.

### EXAMPLE 1

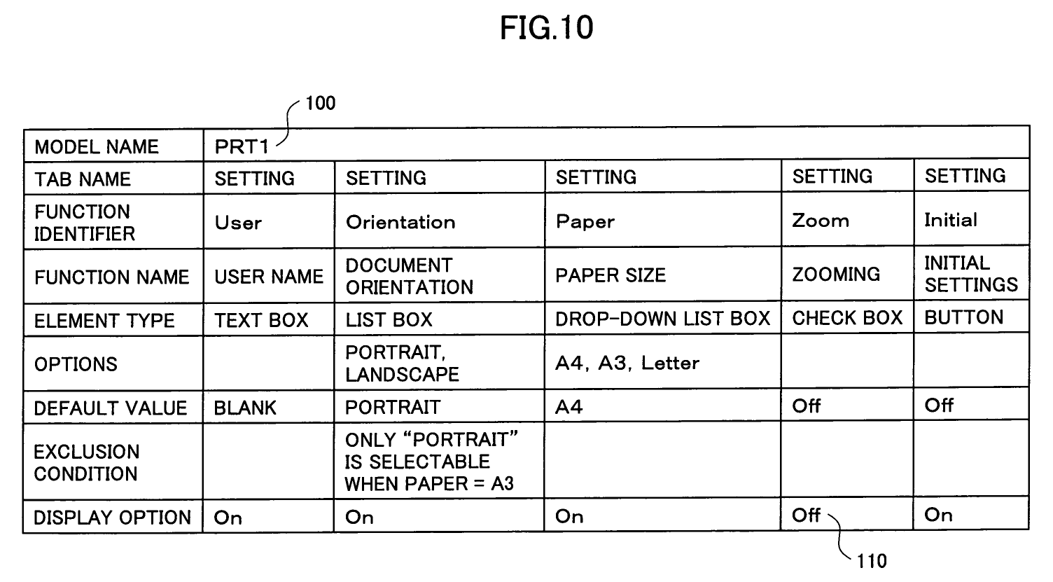

In example 1, it is assumed that the “Zooming” function is not available in the printer 14 and basic function information shown in FIG. 6 is initially stored in the function information storage unit 40 of the information processing apparatus 10. The basic function information is updated through steps as described above with reference to FIG. 8 and stored as UI display information as shown in FIG. 10. In FIG. 10, a model name 100 has been changed from “Universal Driver” (in FIG. 6) to “PRT1” that is the name of the printer 14 and a display option 110 of the “Zooming” function entry has been changed from “On” (in FIG. 6) to “Off”.

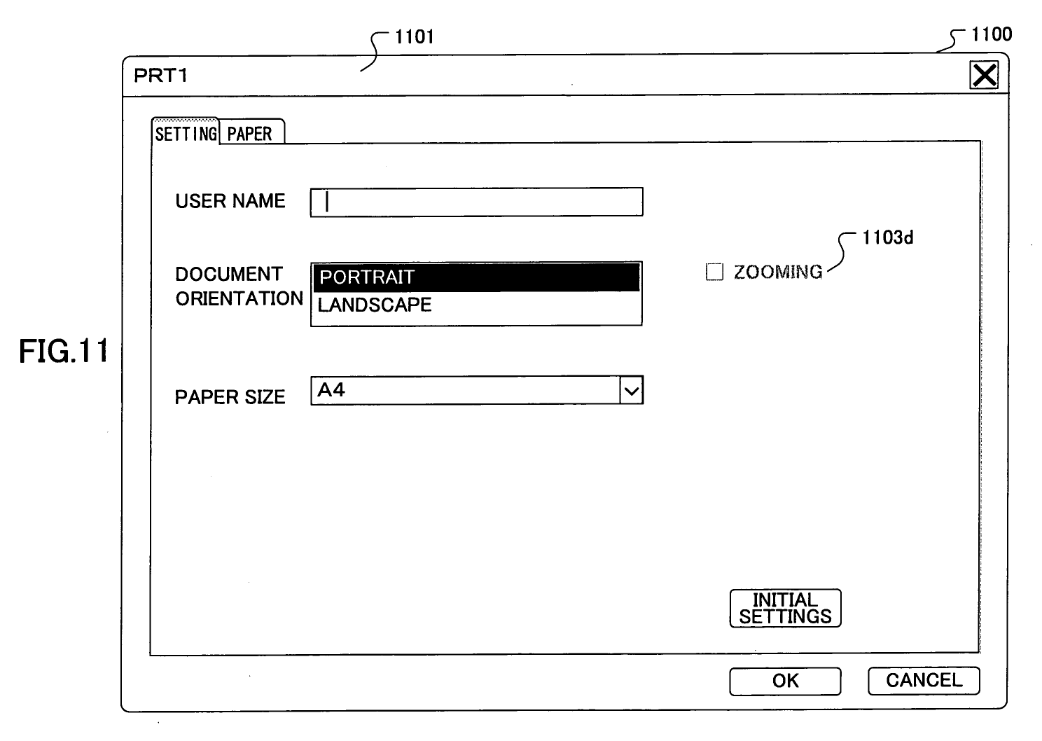

A basic setting screen as shown in FIG. 5, which is common to multiple printers, is generated by the setting screen generating unit 421 based on the basic function information shown in FIG. 6. The basic setting screen is updated to a setting screen 1100 shown in FIG. 11 based on the UI display information shown in FIG. 10 through steps as described above with referent to FIG. 9. On the setting screen 1100 shown in FIG. 11, a model name 1101 has been changed from “Universal Driver” (in FIG. 5) to “PRT1” that is the name of the printer 14 and a “Zooming” setting element 1103d has been dimmed so that the user cannot use this setting element.

### EXAMPLE 2

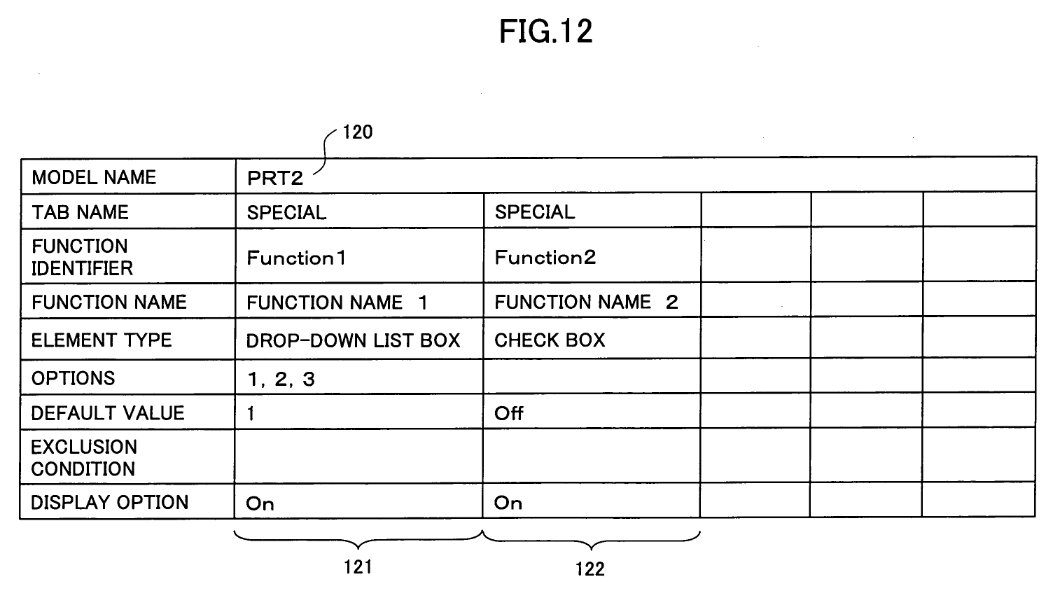

In example 2, it is assumed that the printer 14 has been upgraded and basic function information shown in FIG. 6 is initially stored in the function information storage unit 40 of the information processing apparatus 10. Function entries shown in FIG. 12 corresponding to two new functions of the upgraded printer 14 are added to the basic function information through steps as described above with reference to FIG. 8 and the updated function information is stored as UI display information.

As shown in FIG. 12, the two new function entries (a first function entry 121 and a second function entry 122) have the same tab name “Special”. The function identifier of the first function entry 121 is “Function 1”, the function name is “Function name 1”, the element type is “drop-down list box”, the options are “1, 2, 3”, the default value is “1”, and the display option is “On”. The function identifier of the second function entry 122 is “Function 2”, the function name is “Function name 2”, the element type is “check box”, the default value is “Off”, and the display option is “On”. A model name 120 of the upgraded printer 14 is “PRT2”.

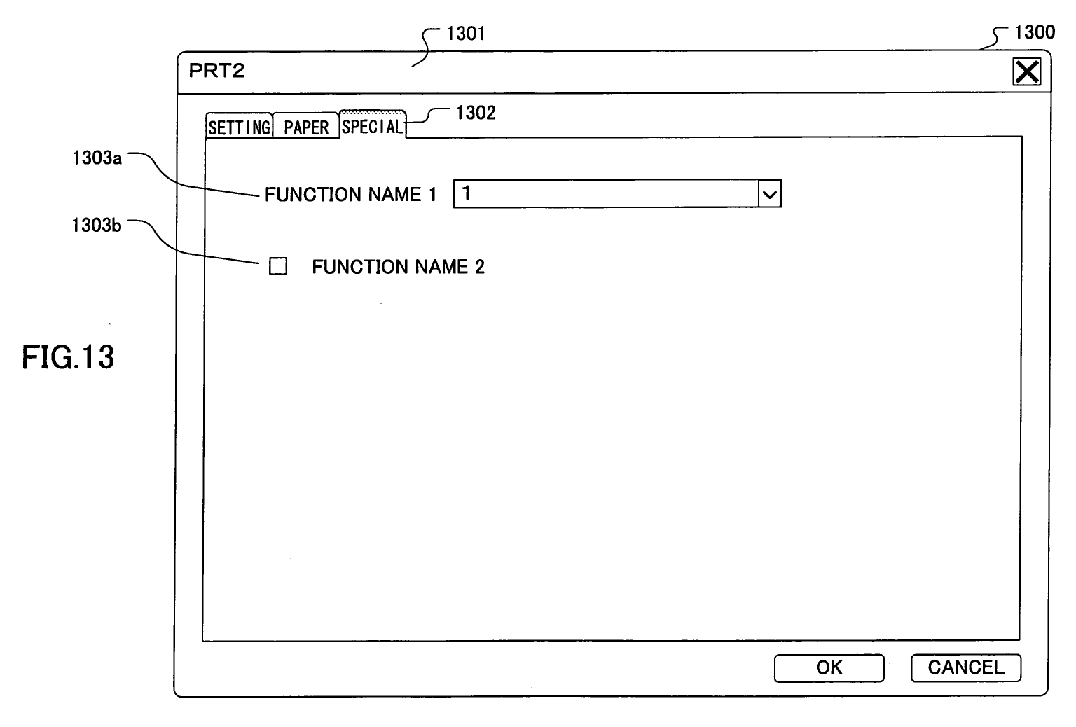

A basic setting screen as shown in FIG. 5, which is common to multiple printers, is generated by the setting screen generating unit 421 based on the basic function information shown in FIG. 6. The basic setting screen is updated to a setting screen 1300 shown in FIG. 13 based on the UI display information shown in FIG. 12 through steps as described above with referent to FIG. 9. On the setting screen 1300 shown in FIG. 13, a model name 1301 has been changed from “Universal Driver” (in FIG. 5) to “PRT2” that is the name of the upgraded printer 14 and a sub-screen with a tab name 1302 “Special” has been added.

The “Special” sub-screen includes setting elements with function names 1303a “Function name 1” and 1303b “Function name 2”. The “Function name 1” setting element corresponds to the first function entry 121 and is implemented as a drop-down list box and the “Function name 2” setting element corresponds to the second function entry 122 and is implemented as a check box. In the “Function name 1” setting element, “1” is selected by default. The “Function name 2” setting element is turned off (the check box is cleared) by default.

[Variations]

Although the above embodiments are implemented by program code stored, for example, in a hard disk drive (HDD) or a read-only memory (ROM) of an information processing apparatus, embodiments of the present invention may be implemented by hardware.

Although a printer driver is used as an example of a device driver to describe the above embodiments of the present invention, the present invention may be applied to any piece of software, such as a scanner driver or a PC-FAX driver, for converting data generated by an application program into data that a device can process. For example, the printer driver 33 shown in FIGS. 3 and 4 may be replaced with another device driver.

Embodiments of the present invention may be applied not only to a device driver or a similar program module but also to an application program. For example, the drawing unit 43 and the UI unit 42 shown in FIGS. 3 and 4 may be incorporated in an application program and the function information storage unit 40 and the communication unit 41 may be provided as separate program modules.

The present invention is not limited to the specifically disclosed embodiments, and variations and modifications may be made without departing from the scope of the present invention.

The present application is based on Japanese Priority Application No. 2006-171606, filed on Jun. 21, 2006, the entire contents of which are hereby incorporated herein by reference.

What is claimed is:

1. An information processing apparatus for generating data that a device connected to the information processing apparatus can process, comprising:
a function information storage unit configured to store function information regarding functions provided by the device;
a configuration information obtaining unit configured to obtain configuration information from the device which configuration information is latest information on the functions provided by the device;
an information comparing unit configured to compare the function information and the configuration information and to update the function information based on results of the comparison; and
a setting screen generating unit configured to generate a setting screen based on the updated function information.

2. The information processing apparatus as claimed in claim 1, wherein the setting screen generating unit is configured to add a setting element representing a new function entry, which new function entry is contained in the configuration information but not in the function information, to the setting screen; and to remove or change appearance of a setting element included in the setting screen and representing an existing function entry that is contained in the function information but not in the configuration information.

3. The information processing apparatus as claimed in claim 2, wherein
the setting screen includes one or more sub-screens; and
the setting screen generating unit is configured to add a sub-screen having the setting element representing the new function entry to the setting screen, and to remove or change appearance of any one of the sub-screens in the setting screen which any one of the sub-screens has the setting element representing the existing function entry.

4. The information processing apparatus as claimed in claim 1, wherein
the updated function information includes an exclusion condition defining relationship between the functions provided by the device; and
the setting screen generating unit is configured to generate a setting element of the setting screen according to the exclusion condition.

5. The information processing apparatus as claimed in claim 1, wherein the function information storage unit is configured to keep the updated function information until a different device is connected to the information processing apparatus.

6. The information processing apparatus as claimed in claim 1, wherein the function information contains one or more of a tab name, a function identifier, a function name, an element type, options, a default value, an exclusion condition, and a display option for each of the functions provided by the device.

7. A recording medium having program code embodied therein for causing a computer to function as the information processing apparatus as claimed in claim 1.
